(19) United States
(12) Patent Application Publication
(10) Pub. No.: US 2023/0050170 A1
(43) Pub. Date: Feb. 16, 2023

(54) METHODS AND APPARATUS OF GROUP SCHEDULING FOR NR MULTICAST SERVICE

(71) Applicant: MediaTek Singapore Pte. Ltd., Singapore (SG)

(72) Inventor: Xuelong Wang, San Jose, CA (US)

(21) Appl. No.: 17/818,626

(22) Filed: Aug. 9, 2022

Related U.S. Application Data
(63) Continuation of application No. PCT/CN2021/076499, filed on Feb. 10, 2021.

(30) Foreign Application Priority Data
Feb. 14, 2020 (CN) PCT/CN2020/075263
Feb. 10, 2021 (CN) PCT/CN2021/076499

(51) Int. Cl. H04W 72/00; H04W 4/06; H04L 1/18

(52) U.S. Cl. CPC H04W 72/005; H04W 4/06; H04L 1/1854

(57) ABSTRACT

Apparatus and methods are provided for group scheduling configuration and uplink HARQ configuration for the NR multicast services. In one novel aspect, the UE receives broadcasts the SIB message related to multicast transmission, receives multicast control information via RRC message, and configures the uplink HARQ feedback. In one embodiment, the SIB message includes control Resource Set and/or search space for MB-RNTI scramble. The multicast control information includes control Resource Set and/or search space within the MTCHinfolist G-RNTI scramble. The multicast control information includes one or more elements including MTCH index, uplink HARQ feedback request to inform the concerned UE(s) the HARQ feedback is disabled or enabled, the timing information between PDSCH and the uplink PUCCH feedback resource, the option of HARQ based feedback, one or a set of PUCCH resource or PUCCH resource instance, and an MTCH retransmission timer.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/076499, titled “Methods and Apparatus of Group Scheduling for NR Multicast Service,” with an international filing date of Feb. 10, 2021. Internal Application No. PCT/CN2021/076499, in turn, claims priority under 35 U.S.C. § 120 and § 365(c) from International Application No PCT/CN2020/075263, titled “Methods and Apparatus of Group Scheduling for NR Multicast Service,” with an international filing date of Feb. 14, 2020. This application is a continuation of International Application No. PCT/CN2021/076499. International Application No. PCT/CN2021/076499 is pending as of the filing date of this application, and the United States is an elected state in International Application No. PCT/CN2021/076499. The disclosure of each of the foregoing documents is incorporated herein by reference.

### TECHNICAL FIELD

The disclosed embodiments relate generally to wireless communication, and, more particularly, to group scheduling for new radio (NR) multicast service.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LTE standard defines enhanced multimedia broadcast multicast services eMBMS. The single-cell point to multipoint (SC-PTM) services and multicast-broadcast single-frequency network (MBSFN) are defined. The early multicast/broadcast services, such as mobile TV services, do not require ACK/NACK-based feedback for the multicast data packets. With the increasingly demand for multicast services for critical communication services such as involving disaster situations and public safety services, the necessity of a reliable multicast data delivery requires improvement of the existing mobile multicast/broadcast services. Currently, the group scheduling, which is based on UMTS or EUTRAN technology, has no uplink feedback support. In the NR network, bandwidth part (BWP) is used for bandwidth efficiency. The current multicast services configurations, however, does not address the BWP configuration needs for the multicast services.

Improvements and enhancements are required for group scheduling configuration and HARQ configuration for the multicast services in the NR network.

### SUMMARY

Apparatus and methods are provided for group scheduling configuration and uplink HARQ configuration for the NR multicast services. In one novel aspect, the gNB broadcasts the SIB message related to multicast transmission, transmits multicast control information via RRC message, schedules the multicast PDSCH transmission, and indicates the uplink HARQ feedback information to the UE. In one embodiment, the SIB message includes control Resource Set and/or search space. Multicast control information includes control Resource Set and/or search space within the MTCHinfolist for searching the PDCCH scrambled by G-RNTI. The multicast control information includes MTCH index (or a MRB index) within the MTCHinfolist. In another embodiment, the multicast control information includes uplink HARQ feedback request to inform the concerned UE(s) the HARQ feedback is disabled or enabled. The multicast control information includes one or more elements including the timing information between PDSCH and the uplink PUCCH feedback resource, the option of HARQ based feedback, one or a set of PUCCH resource or PUCCH resource instance for the PDSCH transmission carrying the MTCH content in MTCH information list per MTCH, and an MTCH retransmission timer.

In one embodiment, the UE receives a broadcasting system information block (SIB) configuration for one or more multicast transmissions in a new radio (NR) network, wherein the broadcasting SIB includes bandwidth part (BWP) for the one or more multicast transmissions, multicast control information for the one or more multicast transmissions through a radio resource control (RRC) message, and receives one or more scheduled multicast transmissions on multicast physical downlink shared channel (PDSCH) based on the multicast control information.

In another embodiment, the UE receives multicast control information for the one or more multicast transmissions through a radio resource control (RRC) message, configures uplink hybrid automatic repeat request (HARQ) feedback for one or more multicast transmission based on the received multicast control information, receives one or more scheduled multicast transmissions on multicast physical downlink shared channel (PDSCH) based on the multicast control information, and sends HARQ feedback for the one or more scheduled multicast transmissions to the NR network based on the HARQ feedback configuration.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network that group scheduling and uplink HARQ for the NR network in accordance with embodiments of the current invention.

FIG. 2 illustrates an exemplary NR wireless system with centralized upper layers of the NR radio interface stacks and UE stack with multicast protocol in accordance with embodiments of the current invention.

FIG. 3 illustrates an exemplary block diagrams for a multicast group scheduling in the NR network in accordance with embodiments of the current invention.

FIG. 4 illustrates exemplary diagrams of mapping among the multicast session, the MTCH, and the multicast radio bearer for the NR multicast service in accordance with embodiments of the current invention.

FIG. 5A illustrates an exemplary Table-1 for the multicast configuration when the MTCH is carried by the initial BWP in accordance with embodiments of the current invention.

FIG. 5B illustrates an exemplary Table-1 for the multicast configuration when the MTCH is carried by a specific BWP in accordance with embodiments of the current invention.

FIG. 6A illustrates an exemplary flow diagram of NR MCCH configuration acquisition in accordance with embodiments of the current invention.

FIG. 6B illustrates an exemplary Table-3 of the MTCInfoList for the NR multicast configuration in accordance with embodiments of the current invention.

FIG. 7 illustrates an exemplary flow chart for the group scheduling configuration with MTCH information for the NR multicast service in accordance with embodiments of the current invention.

FIG. 8 illustrates an exemplary flow chart for the group scheduling configuration with uplink HARQ for the NR multicast service in accordance with embodiments of the current invention.

### DETAILED DESCRIPTION

Reference will now be made in detail to some embodiments of the invention, examples of which are illustrated in the accompanying drawings.

In the NR network, HARQ-ACK feedback for unicast transmission is supported. Multiple DL HARQ Process per UE is supported. Single DL HARQ Process per UE is supported as well. The UE is required to indicate its capability of minimum HARQ processing time, which is the minimum HARQ processing time required from DL data reception to the corresponding HARQ-ACK transmission. From UE perspective, HARQ ACK/NACK feedback for multiple physical downlink shared channels (PDSCHs) in time can be transmitted in one UL data/control region. The timing between the PDSCH reception and corresponding ACK/NACK is specified in DCI (e.g. in DCI 1_0, DCI 1_1). CBG (Code Block Group)-based transmission with single/multi-bit HARQ-ACK feedback is also supported. It only allows CBG based (re)-transmission for the same TB of a HARQ process. A CBG can include all CBs of a TB regardless of the TBS (TB Size). A TB is made up of only one CBG. The UE reports single HARQ ACK bit for the TB. A CBG can have only one CB. CBG granularity is configurable by higher layer. The HARQ-ACK codebook is used for the NR network. There is the CBG-based HARQ-ACK codebook determination. Two different types of codebook determination algorithm called Type 1 and Type 2 are available for the NR network. Each of these types is divided into two cases depending on whether the HARQ ACK is reported in PUCCH or PUSCH. The type of algorithm is determined by a couple of RRC parameters. NR-V2X supports HARQ based on transmission of ACK/NACK (or DTX) for sidelink unicast and groupcast services, as well as a NACK-only HARQ scheme particular to groupcast services. In addition, it supports blind re-transmission schemes. Sidelink HARQ feedback is carried on physical sidelink feedback channel (PSFCH) from an Rx UE to its Tx UE. When ACK/NACK (or DTX) operation is used, the HARQ procedure is similar to the NR Uu scheme for non-codeblock group feedback. The ACK/NACK is delivered based on the success or failure of the whole transport block. The NACK-only operation is defined for groupcast to allow a potentially lower sidelink resource demand to be created when a larger number of Rx UEs that need to send feedback to the same Tx UE. Sidelink groupcast has the similar characteristics as NR Multicast services.

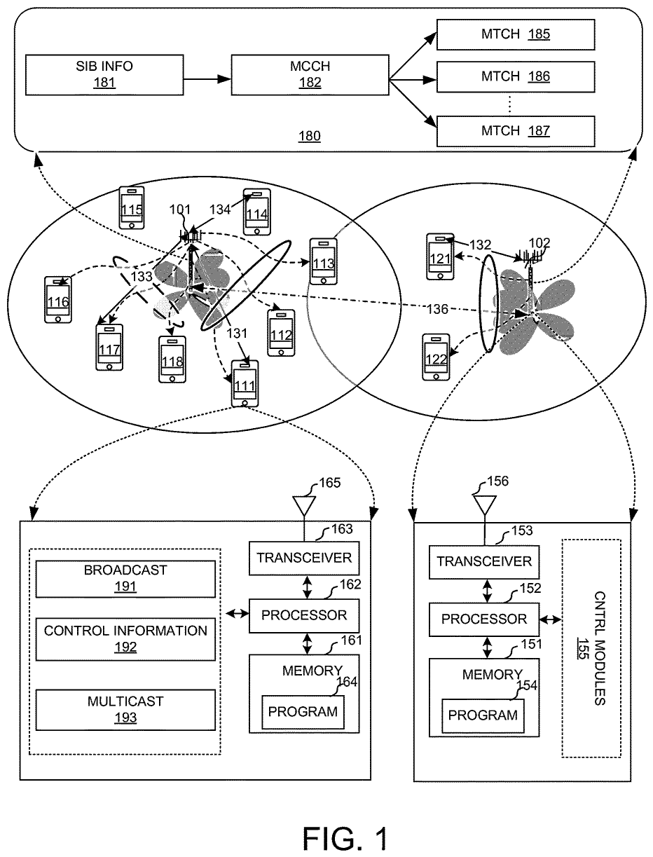

FIG. 1 is a schematic system diagram illustrating an exemplary NR wireless network that group scheduling and uplink HARQ for the NR network in accordance with embodiments of the current invention. The NR wireless system includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 and gNB 102 base stations in the NR network, the serving area of which may or may not overlap with each other. The backhaul connection such as 136, connects the non-co-located receiving base units, such as gNB 101 and gNB 102. These backhaul connections can be either ideal or non-ideal. gNB 101 connects with gNB 102 via Xnr interface 136.

NR wireless network 100 also includes multiple communication devices or mobile stations, such as user equipments (UEs) 111, 112, 113, 114, 116, 117, 121 and 122. The mobile devices can establish one or more unicast connections with one or more base stations. For example, UE 111 has unicast connect 131 with gNB 101. UEs 114 and 117 connect with gNB 101 with unicast connections 134 and 133, respectively. Similarly, UEs 121 connects with gNB 102 with unicast connections 132.

In one novel aspect, group scheduling for multicast services are configured. A multicast service-1 is provided by gNB 101 and gNB 102. UEs 111, 112 and 113 receive multicast services from gNB 101. UEs 121 and 122 receive multicast services from gNB 102. Multicast service-2 is provided by gNB 101 to the UE group of UEs 116, 117, and 118. Multicast service-1 and multicast service-2 are delivered in multicast mode with a multicast radio bearer (MRB) configured by the NR wireless network. The receiving UEs receives data packets of the multicast service through corresponding MRB configured. UE 111 receives multicast service-1 from gNB 101. gNB 102 provides multicast service-1 as well. Uplink feedback are configured for the multicast services. Each UE receiving the multicast indicates whether the HARQ is supported. An indication the type of the uplink feedback is also configured. In one embodiment, the uplink feedback is a NACK-only feedback. In another embodiment, the uplink feedback is a NACK and ACK-based feedback.

FIG. 1 illustrates an exemplary procedure 180 for multicast configuration with group scheduling. NR multicast is transmitted in the coverage of a cell. From logical channel perspective, one multicast control channel (MCCH) and one or more multicast traffic channels (MTCHs) are mapped on downlink shared channel (DL-SCH). The scheduling for NR multicast is done by the gNB central unit (gNB-CU). MCCH provides the list of all NR multicast services with ongoing sessions transmitted on MTCH(s), including each NR multicast service ID (expressed by NR multicast group ID or NR multicast session ID), associated group radio network temporary identifier (G-RNTI), scheduling information, etc. MCCH is transmitted by RRC every MCCH repetition period. MCCH uses a modification period. MCCH and MTCH use the RLC-UM mode or RLC-AM mode. A SIB broadcasting 180 includes multicast information in the SIB information. Based on the SIB information for the multicast services, MCCH information is obtained at 180. The MCCH information can be included in the system information or through RRC messages. The MCCH information configures multiple MTCHs, such as MTCH 185, MTCH 186, and MTCH 187. In one embodiment, BWP-related configuration are included for the configuration procedure 180. In another embodiment, uplink feedback, such as HARQ are also configured in configuration procedure 180.

FIG. 1 further illustrates simplified block diagrams of a base station and a mobile device/UE for multicast group scheduling. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations.

FIG. 1 also includes simplified block diagrams of a UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 102.

The UE 111 also includes a set of control modules that carry out functional tasks. These control modules can be implemented by circuits, software, firmware, or a combination of them. A broadcast module 191 receives a broadcasting system information block (SIB) configuration for one or more multicast transmissions in the NR network, wherein the broadcasting SIB includes bandwidth part (BWP) for the one or more multicast transmissions. A control information module 192 receives multicast control information for the one or more multicast transmissions through a radio resource control (RRC) message. A multicast module 193 receives one or more scheduled multicast transmissions on multicast physical downlink shared channel (PDSCH) based on the multicast control information.

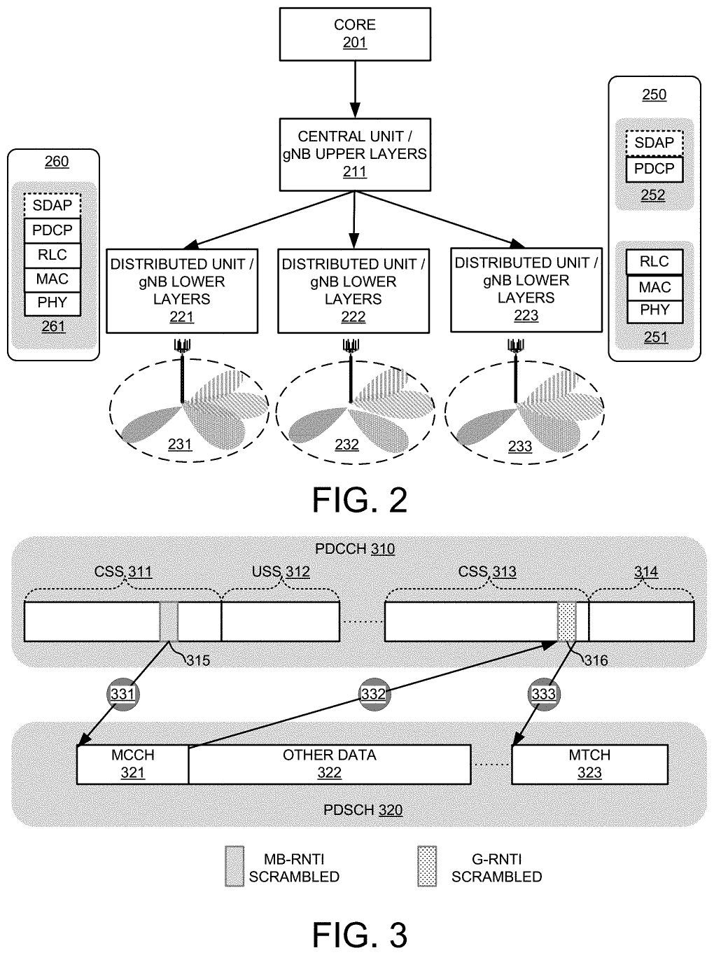

FIG. 2 illustrates an exemplary NR wireless system with centralized upper layers of the NR radio interface stacks and UE stack with multicast protocol in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, RLC, MAC and PHY layers.

FIG. 3 illustrates an exemplary block diagrams for a multicast group scheduling in the NR network in accordance with embodiments of the current invention. An exemplary PDCCH 310 includes common search space (CSS) 311 and 313, UE-specific search space (USS) 312, and 314. An exemplary PDSCH 320 includes MCCH 321, other data fields 322 and MTCH 323. The MCCH 321 is scheduled by gNB in the CSS 311 of PDCCH with multimedia broadcast RNTI (MB-RNTI) scrambled. MB-RNTI is MCCH logical channel specific RNTI, with fixed value specified in MAC (e.g., the value can be FFFD). MTCH 323 is scheduled by gNB in the CSS 313 of PDCCH with group RNTI (G-RNTI) scrambled. At step 331, the UE searches the common search space 311 of PDCCH 310 with MB-RNTI according to the primary indication within Cell system information. The UE reads the MCCH control information. At step 332, the UE monitors the common search space of PDCCH with G-RNTI according to the MCCH control information for a particular MTCH. The UE detects G-RNTI scrambled MTCH 323 information in CSS 316 at PDCCH 310. At step 333, the UE decodes the MTCH data 323 for a multicast session in PDSCH 320 according to the resource indicated by DCI.

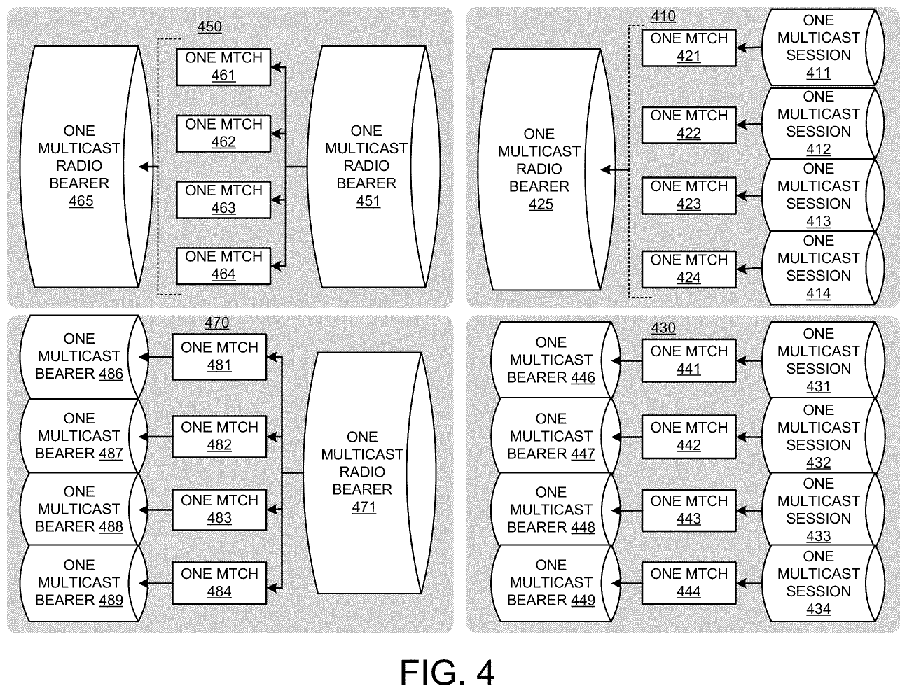

FIG. 4 illustrates exemplary diagrams of mapping among the multicast session, the MTCH, and the multicast radio bearer for the NR multicast service in accordance with embodiments of the current invention. The NR multicast service configuration configures the multicast session with corresponding MTCH and multicast radio bearers (MRBs). One multicast session, indicated by a multicast session ID, corresponds to one multicast group, indicated by a multicast group ID. Four configurations 410, 430, 450, and 470 are illustrates.

Configuration 410 presents one-to-one mapping between NR multicast sessions and MTCHs, and many-to-one mapping between NR multicast session and multicast Radio Bearer. Multicast sessions 411, 412, 413, and 414, map to MTCHs 421, 422, 423, and 424, respectively. MTCHs 421, 422, 423, and 424 map to one multicast radio bearer 425. There is only one multicast Radio Bearer 425 supported within one NR cell. Alternatively, one multicast Radio Bearer 425 is supported for one multicast session. In this case, there is a one-to-one mapping between G-RNTI and multicast session ID (and/or multicast group ID).

Configuration 430 presents one-to-one mapping between NR multicast session and MTCH, and one-to-one mapping between NR multicast session and multicast Radio Bearer (each carrying a single MTCH). Multicast sessions 431, 432, 433, and 434 map to MTCHs 441, 442, 443, and 444, respectively. MTCHs 441, 442, 443, and 444 map to multicast radio bearers 446, 447, 448, and 449, respectively. There are multiple multicast Radio Bearers supported within one NR cell. There is a one-to-one mapping between G-RNTI and multicast session ID (and/or multicast group ID).

Configuration 450 presents one-to-many mapping between NR multicast session and MTCH, and many-to-one mapping between NR multicast session and multicast Radio Bearer. One multicast session 451 maps to multiple MTCHs 461, 462, 463, and 464. MTCHs 461, 462, 463, and 464 map to one multicast radio bearer 465. The NR multicast session maps to one multicast Radio Bearer. There is one multicast Radio Bearers supported within one NR cell. Alternatively, one multicast Radio Bearer is supported for one multicast session. There is a one-to-many mapping between multicast session ID (and/or multicast group ID) and G-RNTI. Multiple different G-RNTI is used to different MTCHs. An MTCH Index is used to identify different MTCHs carrying the same multicast session.

Configuration 470 presents one-to-many mapping between NR multicast session and MTCH, and one-to-many mapping between NR multicast session and multicast Radio Bearer (each carrying a single MTCH). One multicast session 471 map to MTCHs 481, 482, 483, and 484. MTCHs 481, 482, 483, and 484 map to multicast radio bearers 486, 487, 488, and 489, respectively. There are multiple multicast Radio Bearers supported within one NR cell. There is a one-to-many mapping between multicast session ID (and/or multicast group ID) and G-RNTI. Multiple G-RNTIs are used for different MTCHs. An MTCH Index is used to identify each MTCH carrying the same multicast session.

The mappings among the multicast session, the MTCH, and the multicast radio bearer follows the rules described above. While configuration 470 is used as exemplary configuration, similar rules apply to other configurations as described above. For each MTCH, a set of scheduling information is provided about the MTCH, including MTCH scheduling cycle, MTCH on-duration, and MTCH inactivity-timer. The MTCH on-duration specifies the duration in downlink subframes or slots that the UE waits for, after waking up from DRX, to receive PDCCHs. If the UE successfully decodes a PDCCH indicating the DL-SCH to which this MTCH is mapped, the UE stays awake and starts the inactivity timer. MTCH inactivity-timer specifies the duration in downlink subframes or slots that the UE waits to successfully decode a PDCCH, from the last successful decoding of a PDCCH indicating the DL-SCH to which this MTCH is mapped. If it fails, the UE re-enters DRX. The UE restarts the inactivity timer following a single successful decoding of a PDCCH. When HARQ feedback is enabled for a particular multicast service and multicast retransmission is expected immediately after NACK based feedback, the corresponding MTCH scheduling information includes MTCH retransmission timer. The active timer for the UE to monitor MTCH includes the time period when the MTCH retransmission timer is running.

A notification mechanism is used to announce changes of MCCH, e.g. due to Multicast Session Start. The notification is sent in the same slot or subframe as the MCCH, using a MB-N-RNTI with its value fixed in MAC specification (e.g., the value can be FFFC). The notification carries one bit. When the UE receives a notification, it acquires the MCCH in the same slot or subframe. The UE detects changes to MCCH, which are not announced by the notification mechanism by monitoring MCCH at the modification period. Upon receiving a change notification, a UE interested to receive NR multicast services acquires the new MCCH information starting from the same slot or subframe. The UE applies the previously acquired MCCH information until the UE acquires the new MCCH information. When the UE is in the RRC_CONNECTED state, the gNB delivers the changed control information for MTCH(s) carrying the NR multicast services that UE is receiving or is interested to receive. The UE stop monitoring on the MCCH control information and/or the notification DCI. The control information for MTCH includes scheduling cycle, MTCH on-duration, and MTCH inactivity-timer. In an addition, MTCH retransmission timer is included for HARQ feedback enabled MTCH transmission. In one embodiment, the control information for MTCH is delivered by an RRC message.

In one embodiment, HARQ is configured for multicast services. Two HARQ feedback options are defined for NR multicast transmission. The first option requires only HARQ NACK feedback. The second option requires both ACK and NACK based HARQ feedback. For the NACK only HARQ feedback, all UEs receiving the multicast data shares a single feedback resource. Only the HARQ NACKs are sent over the feedback resource. For the HARQ feedback with both NACK and ACK, the UEs receiving the multicast data is configured with separate feedback resources for uplink feedback. A set of orthogonal feedback resources is used for HARQ feedbacks from different UEs. A PUCCH resource instance indicates a particular PUCCH resource associated with a specific cyclic shift. For example, for a particular PUCCH resource, if there are three cyclic shifts configured by gNB, there are three PUCCH resource instances. The uplink (PUCCH) feedback resource means PUCCH resource, PUCCH resource instance, or their combinations.

In the NR system, a new broadcast SIB (e.g. SIBx) is defined to carry the information related to multicast (and broadcast) transmission. It contains the information required by UE to acquire the control information associated with the transmission of NR multicast (and broadcast) service. In NR, the BWP is defined within one carrier. The system information (e.g. SIB1) is delivered over the initial BWP. One BWP has its specific frequency location and bandwidth within a certain carrier. In addition, within one BWP, the subcarrier spacing and cyclic prefix is the same. It means the numerology within one BWP is consistent. The NR multicast and broadcast services are configured with the initial BWP or a specific BWP. MTCH configuration for MTCH information are updated to include the BWP configuration for the multicast services.

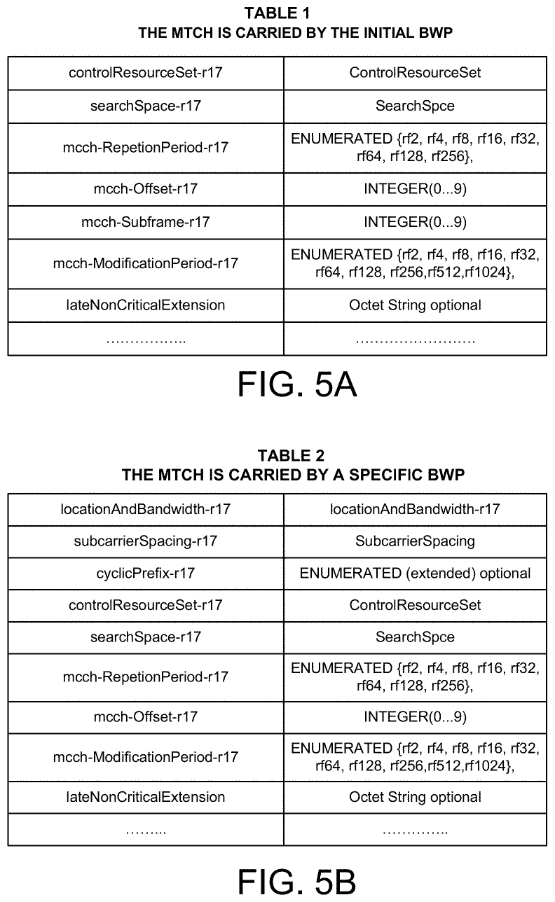

FIG. 5A illustrates an exemplary Table-1 for the multicast configuration when the MTCH is carried by the initial BWP in accordance with embodiments of the current invention. To support NR multicast and/or broadcast, a Common Frequency Resource (i.e. CFR) within the initial BWP is configured to carry MTCH such that both the RRC_CONNECTED UE and the RRC_IDLE UE receive the multicast/broadcast services. MCCH control information is transmitted over the initial BWP. The control Resource Set and/or search space indicated by a search space ID, is transmitted over the broadcasting SIB indicating a search space of a PDCCH to help the UE to search the PDCCH scrambled by MB-RNTI. Alternatively, the search space for MB-RNTI is in the legacy information element (IEs), PDCCH-configcommon. The definition of both control Resource Set and search space ID follows the legacy definition within TS38.331. The timing information elements of MCCH reception (e.g. mcch-RepetionPeriod) are included in the SIB. Table-1 illustrates some IEs in for the multicast configuration with the initial BWP.

FIG. 5B illustrates an exemplary Table-1 for the multicast configuration when the MTCH is carried by a specific BWP in accordance with embodiments of the current invention. A specific BWP is configured to transmit the NR multicast and/or broadcast services. Both the RRC_CONNECTED UE and the RRC_IDLE UE receives the multicast and/or broadcast services. The BWP information, including the frequency location, the frequency bandwidth, the subcarrier spacing and the cyclic prefix, are notified through SIB. The control Resource Set and/or search space indicated by a search space ID is transmitted over the SIB to help the UE to search the PDCCH scrambled by MB-RNTI. The definition of BWP information, control Resource Set and search space follow the legacy definition as described within TS38.331. In the end, the timing information elements of MCCH reception (e.g. mcch-RepetionPeriod) are included in the SIB following legacy behavior. Table-2 illustrates some IEs in for the multicast configuration with the specific BWP configured. Alternatively, the specific BWP can be a Common Frequency Resource (i.e. CFR) within the initial BWP or a dedicated BWP shared by all UEs participating the reception of the Multicast/Broadcast service.

As shown, NR multicast control information is provided on a specific logical channel, e.g. MCCH. The MCCH carries the RRC message, MCCHConfiguration, which indicates the ongoing NR multicast sessions and the corresponding scheduling information for each session. The scheduling information includes scheduling period, scheduling window and start offset. The MCCHConfiguration message provides information about the neighbor cells with ongoing NR multicast sessions that are also transmitted on the current cell. The MCCH information (i.e. information transmitted in messages sent over MCCH) is transmitted periodically, using a configurable repetition period. MCCH transmissions and the associated radio resources and MCS are indicated on PDCCH. Changes of MCCH information only occurs at specific radio frames indicated by the modification period. Within a modification period, the same MCCH information is transmitted a number of times defined by its scheduling repetition period. The modification period boundaries are defined by SFN values for which SFN mod m=0, where m is the number of radio frames comprising the modification period, as defined in a NR multicast specific SIB.

The NR multicast capable UE is receiving or interested to receive NR multicast service(s) via MRB (Multicast Radio Bearer). UE sends the interest indication via RRC message to gNB during connected state. During MCCH configuration information acquisition, the UE acquires the MCCH control information that is broadcast by the gNB. The NR multicast reception applies to NR multicast capable UEs that are in RRC_IDLE or in RRC_CONNECTED. A UE interested to receive NR multicast services via MRB acquires MCCH information upon entering the cell broadcasting the NR multicast specific SIB (e.g. upon power on, following UE mobility) and upon receiving a notification that the MCCH information has changed. The occasion for this acquisition is at the next repetition period. The UE also acquires the MCCH information at the start of each MCCH modification period when the UE is receiving one or more NR multicast service(s). A new acquired MCCH information overwrites any stored MCCH information.

In one embodiment, the UEs, with NR multicast enabled, in RRC_CONNECTED or in RRC_IDLE, and are interested to receive one or more NR multicast services via an MRB, do not need to configure SDAP entity and PDCP entity for this MRB. In another embodiment, the UE establishes an SDAP entity and a PDCP entity for this MRB. In one embodiment, the SDAP entity is shared by multiple MRBs within a NR multicast session corresponding to a NR multicast service when multiple MRBs are used to carry different NR multicast flows within one NR multicast session. The UE configures RLC, MAC and the physical layer upon starting to receive an MRB transmitted on MTCH. The establishment procedure for MRB is triggered one or more triggering event, including the start of the NR multicast session, the entering a cell providing NR multicast service in which the UE has interest, initiating a request for the NR multicast service, and the removal of UE capability limitations inhibiting reception of the concerned service. Upon MRB establishment, the UE establishes an RLC entity, and configures a MTCH logical channel applicable for the MRB, and instructs the MAC layer to receive DL-SCH on the cell where the MCCHConfiguration message was received for which the MRB is established. The UE uses the G-RNTI and DRX parameters for this service. The UE also configures the physical layer in accordance with the MTCH information applicable for the MRB, as included in the MCCHConfiguration message and informs upper layers about the establishment of the MRB by indicating the corresponding NR multicast group ID and/or NR multicast session ID. The MAC entity monitors PDCCH for MB-RNTI and/or for G-RNTI during the subframe or slot as configured. If a specific DCI has been received on the PDCCH for the MB-RNTI or G-RNTI. The HARQ entity of MAC entity together with physical layer attempts to decode the received data and delivers the decoded MAC PDU to the disassembly and demultiplexing entity.

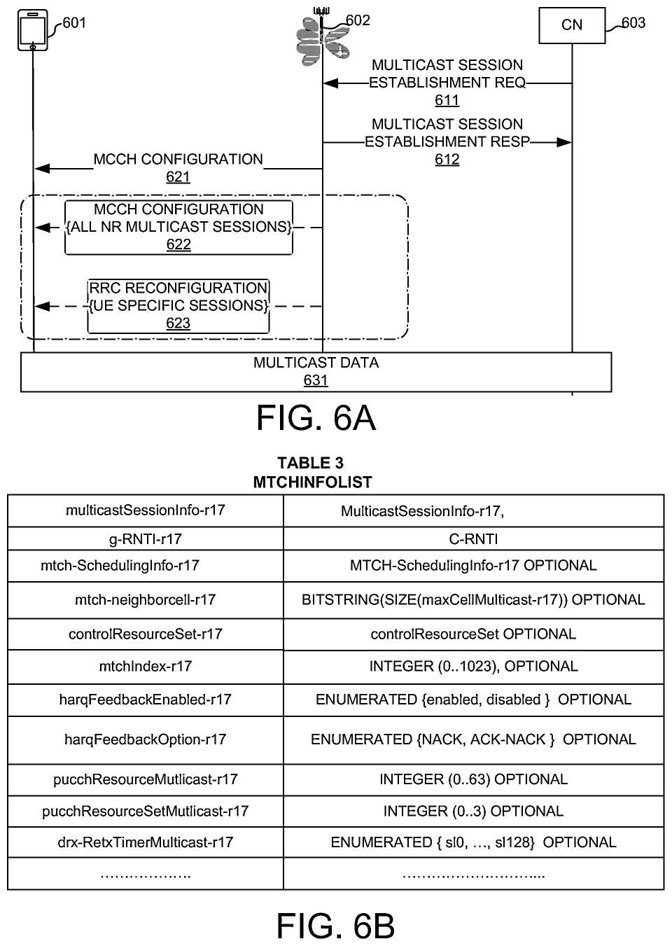

FIG. 6A illustrates an exemplary flow diagram of NR MCCH configuration acquisition in accordance with embodiments of the current invention. The NR wireless network includes a UE 601, a gNB 602 and a core network (CN) entity 603. At step 611, CN 603 sends the NR multicast session establishment request to gNB 602 to establish a new NR multicast transmission or modify an existing NR multicast transmission. At step 612, gNB 602 acknowledges a response message to CN 603 for the NR multicast session establishment request message.

At step 621, a specific RRC message MCCHConfiguration is delivered over air interface. Step 621 has two optional embodiments shown in steps 622 and 623. In the first embodiment, as in step 622, MCCHConfiguration indicates all the ongoing NR multicast sessions via a MTCH information list e.g. MTCHinfolist and a list of neighbor cells e.g. Multicastneighborcelllist transmitting the NR multicast session. The neighbor cells list can be provided per MCCH (i.e. for all NR multicast sessions) or per MTCH (i.e. for one NR multicast session). In the second embodiment, as in step 623, these control information delivered via MCCHConfiguration are sent to the RRC_Connected UE via dedicated signalling with MTCH information that is interested to the UE. It is delivered within a RRC Reconfiguration from gNB 602 to UE 601. A short version of the control information is captured in the RRC Reconfiguration message holding only MTCH information that is concerned by the UE (i.e. UE is receiving or interested to receive). At step 631, the multicast data are received by the UE 601.

FIG. 6B illustrates an exemplary Table-3 of the MTCInfoList for the NR multicast configuration in accordance with embodiments of the current invention. The MTCHinfoList includes one or more elements comprising the multicast Session Information, G-RNTI, MTCH scheduling information, and multicast neighbor cell list. Table-3 illustrates exemplary configurations in the MTCinfolist.

The multicast control information, including the control Resource Set and/or the search space ID indicating a search space of PDCCH scramble by a G-RNTI, are transmitted over the MTCHinfolist. The UE searches the PDCCH scrambled by G-RNTI based on the control resource set and/or search space information. The scheduling information of MTCH reception is included in MTCHinfolist. In one embodiment, one or more MTCH/multicast indexes (or a MRB indexes) are included within the multicast control information of MTCHinfolist to map different multicast resources of MTCH (i.e. MRB) mapped to the one or more different NR multicast flow(s) of a single multicast session.

In one embodiment, uplink HARQ is configured. The uplink HARQ feedback request is embedded in the multicast control information of MTCHinfolist to inform the UE whether the HARQ feedback is disabled or enabled. When the HARQ feedback is enabled, the timing information (with unit of subframe or slot) between the PDSCH and the uplink PUCCH feedback resource (e.g. pdsch-to-HARQ-FBTiming or pdsch-to-HARQ-FeedbackTiming) is included in the multicast control information of MTCHinfolist. If the HARQ feedback is enabled for a MTCH, options of HARQ based feedback are included. The MTCHinfolist indicates whether a NACK-only HARQ is enabled or a NACK and ACK HARQ is enabled.

In one embodiment, the physical layer feedback resource of the PDSCH transmission carrying the MTCH content are included in the MTCH information list per MTCH. In a first embodiment, all UEs share the same uplink feedback resource with NACK only HARQ feedback. A single uplink feedback resource or uplink feedback resource instance (e.g. pucchResourceMulticast) is included as a single entry within MTCHinfolist (i.e. for each MTCH). In a second embodiment, the UEs receiving the multicast data utilize separate uplink feedback resource or feedback resource instance for uplink feedback. In this case, the physical layer feedback resources include a set of PUCCH resources or a set of PUCCH resource instances. A set of uplink PUCCH feedback resources (e.g. pucchResourceSetMulticast) is included into a single entry within MTCHinfolist. An MTCH retransmission timer is included in the multicast control information of MTCHinfolist for HARQ feedback enabled MTCH transmission to enable immediate retransmission for unsuccessful multicast PDSCH transmission. Alternatively, the mtch-retransmission-timer is included in mtch-schedulingInfo-r17. The pucch-ResourceMulticast and pucch-ResourceSetMulticast for uplink HARQ feedback are included within the existing IE PUCCH-ConfigCommon, which is transmitted to UE via system information or RRC dedicated signaling. In yet another embodiment, pucch-ResourceMulticast and pucch-ResourceSetMulticast are included in the dedicated PUCCH-Config (e.g. in RRC reconfiguration) for multicast uplink feedback at HARQ.

In other embodiments, the NR multicast are configured with multicast DCI. The existing DCI format 1_0 or DCI format 2_0 as specified by NR is used to carry the control information for the PDSCH transmitting MTCH information. In another embodiment, a new DCI format (similar to DCI format 1_0) is defined to carry the control information for multicast PDSCH transmission of multicast traffic data. DCI_X is used in the remaining description of the present disclosure for this DCI. For unicast PDSCH data transmission, the DCI format 1_0 is transmitted with CRC scrambled by C-RNTI. For multicast PDSCH transmission, the DCI_X is transmitted with CRC scrambled by G-RNTI. A new field to enable HARQ feedback (e.g., one-bit harqFeedbackEnabled, where 1 is enabled and 0 is disabled) is added into DCI_X to indicate the feedback request for the corresponding multicast PDSCH transmission.

In a first option, all the UEs share a feedback resource in a physical channel (e.g. PUCCH) and multiple UEs transmit NACK in SFN manner. In a second option, each UE uses a separate feedback resource in a physical channel (e.g. PUCCH) for HARQ ACK/NACK. The multicast control information includes a HARQ feedback option selecting from a NACK HARQ feedback and an ACK/NACK HARQ feedback. If the HARQ feedback is enabled for multicast PDSCH transmission, a new field to indicate the HARQ feedback option (e.g., one-bit harqFeedbackOption, where 0 is NACK based feedback and 1 is ACK-NACK based feedback) is added into DCI_X to indicate the feedback option for the corresponding multicast PDSCH transmission. If the HARQ feedback is enabled for multicast PDSCH transmission, a new field to indicate the HARQ feedback timing in unit of subframe or slot (e.g. 3-bit pdsch-to-HARQ-Feedback Timing) between multicast PDSCH transmission and the corresponding uplink channel (e.g. PUCCH) feedback resource can also be indicated in DCI_X for multicast PDSCH transmission, which is an alternative way to convey the information to the UE, when it is not delivered to the UE via RRC message MCCHConfiguration. The PUCCH resource indicator can be indicated within the DCI_X, which is an alternative way to convey the information to the UE, when it is not delivered to the UE via RRC message MCCHConfiguration. the PUCCH resource indicator indicates one or a set of specific PUCCH resource or PUCCH resource instance for uplink feedback of multicast PDSCH transmission. The PUCCH resource indicator has different mean for the two HARQ feedback options. When the first HARQ feedback option applies, the PUCCH resource indicator indicates a concrete PUCCH resource as DCI format 1_0 does, or a concrete PUCCH resource instance (with fixed cyclic shift). When the second HARQ feedback option applies, the PUCCH resource indicator indicates a set of PUCCH resource (e.g., 16 PUCCH resources) or a set of PUCCH resource instance (e.g., 64 PUCCH resource instance). An example set of fields included within the DCI_X for multicast PDSCH transmission when HARQ feedback is enabled:

| | |
|---|---|
| Identifier for DCI format | 1 bit, same as DCI format 1_0 |
| Frequency domain resource | Variable bits, same as DCI 1_0 |
| assignment | |
| Time domain resource | 4 bits, same as DCI format 1_0 |
| assignment | |
| VRB-to-PRB mapping | 1 bit, same as DCI format 1_0 |
| MCS | 5 bits, same as DCI format 1_0 |
| New Data Indicator | 1 bit, same as DCI format 1_0 |
| Redundancy Version | 2 bit, same as DCI format 1_0 |
| HARQ process number | 4 bits, same as DCI format 1_0 |
| DL assignment index | 2 bits, same as DCI format 1_0 |
| TPC command for scheduled | 2 bits, same as DCI format 1_0 |
| PUCCH | |
| PDSCH-to-HARQ-feedback | 3 bits, same as DCI format 1_0 |
| timing | |
| PUCCH resource Indicator | 4 bits, set ID or resource ID |
| | for feedback |
| HARQ feedback enabled | 1 bit, 0: non enabled, 1: enabled |
| HARQ feedback option | 1 bits, 0: NACK only, 1: both |
| | ACK and NACK |

In the example NR system, the existing DCI format 1_0 or DCI format 2_0 as specified by NR is used to carry the control information for the PDSCH transmitting MCCH information. Alternatively, a new DCI format (similar to DCI format 1_0 or DCI format 2_0) is defined to carry the control information for multicast PDSCH transmission of MCCH information. DCI_Y is used in the remaining description of the present disclosure for this DCI. DCI_Y is transmitted with CRC scrambled by MB-RNTI. An example set of fields included within the DCI_X for multicast PDSCH transmission is shown below for the case HARQ feedback is enabled:

| | |
|---|---|
| Frequency domain resource | Variable bits, same as DCI 1_0 |
| assignment | |
| Time domain resource | 4 bits, same as DCI format 1_0 |
| assignment | |
| VRB-to-PRB mapping | 1 bit, same as DCI format 1_0 |
| MCS | 5 bits, same as DCI format 1_0 |
| Reserved bit | Variable bits |

As an option, the field Redundancy Version (2 bit, same as DCI format 1_0) can be included DCI_Y to indicate the RV of the HARQ transmission if blind retransmission is supported for transmitting MCCH information. The existing DCI format 2_0 as specified by NR is used to carry the notification of the change of multicast PDSCH transmission for MCCH information. Alternatively, a new DCI format (similar to DCI format 2_0) is defined to carry the notification for multicast PDSCH transmission of MCCH information. DCI_Z is used in the remaining description of the present disclosure for this DCI. DCI_Z is transmitted with CRC scrambled by MB-N-RNTI. One-bit is used to notify the change of MCCH information in the DCI_Z. Alternatively, the One-bit notification (or DCI_Z) is piggybacked by a DCI format (e.g., DCI format 1_0) used for unicast PDSCH transmission. This achieves the effect of joint DCI for both unicast transmission and multicast notification.

Specific to the uplink HARQ feedback for multicast PDSCH transmission, the PUCCH transmission format is based on NR PUCCH Format 0 or PUCCH Format 1. It is a sequence based HARQ feedback (i.e. 1 bit). As one option, NR PUCCH Format 0 is reused for uplink HARQ feedback for multicast PDSCH transmission. Alternatively, a new UCI format is defined. UCI_X is used in the remaining description of the present disclosure for this UCI. The base sequence to generate the transmission of the one-bit feedback of UCI_X is same as the base sequence of NR PUCCH Format 0 or PUCCH Format 1. CBG based HARQ feedback is not supported for UCI_X. After receiving NACK feedback from the UE within the multicast group, gNB schedules the retransmission via PDCCH following the scheduling pattern as configured for MTCH. UE DRX behavior for multicast reception is kept without initiating the retransmission timer for multicast reception. Alternatively, gNB provides additional resources for retransmission upon receiving a multicast NACK report, a dynamic DL resource scheduling is used. After sending multicast NACK report, UE initiates the retransmission timer for multicast and monitors the PDCCH from the succeeding subframe(s) using G-RNTI. In this case, one DRX timer (e.g., drx-retransmission-timer) is added into the MTCH configuration to support HARQ retransmission.

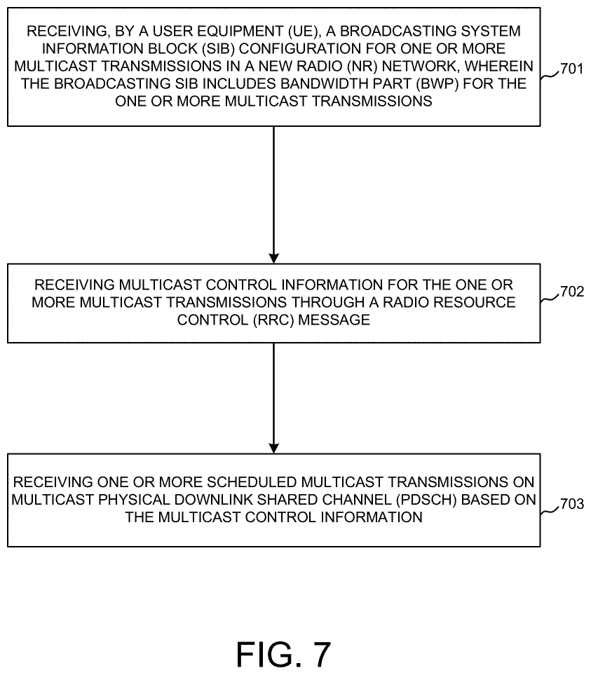

FIG. 7 illustrates an exemplary flow chart for the group scheduling configuration with MTCH information for the NR multicast service in accordance with embodiments of the current invention. At step 701, the UE receives a broadcasting system information block (SIB) configuration for one or more multicast transmissions in a new radio (NR) network, wherein the broadcasting SIB includes bandwidth part (BWP) for the one or more multicast transmissions. At step 703, the UE receives multicast control information for the one or more multicast transmissions through a radio resource control (RRC) message. At step 703, the UE receives one or more scheduled multicast transmissions on multicast physical downlink shared channel (PDSCH) based on the multicast control information.

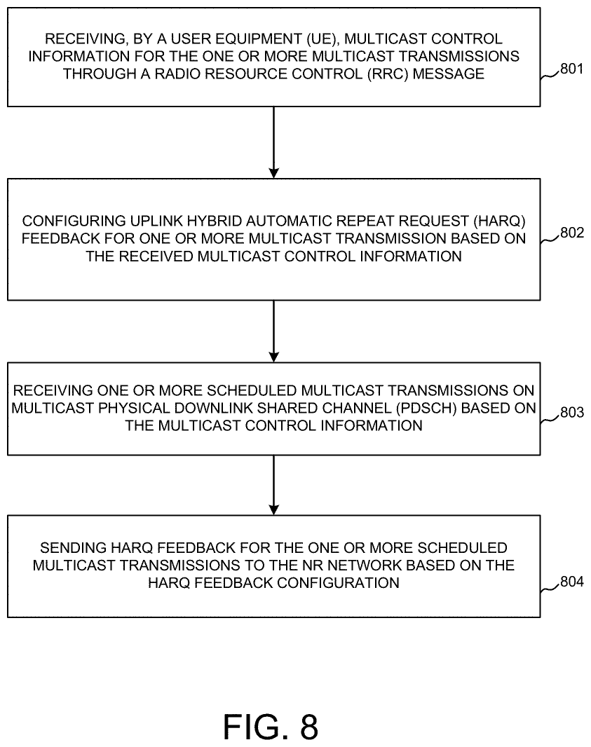

FIG. 8 illustrates an exemplary flow chart for the group scheduling configuration with uplink HARQ for the NR multicast service in accordance with embodiments of the current invention. At step 801, the UE receives multicast control information for the one or more multicast transmissions through a radio resource control (RRC) message. At step 802, the UE configures uplink hybrid automatic repeat request (HARQ) feedback for one or more multicast transmission based on the received multicast control information. At step 803, the UE receives one or more scheduled multicast transmissions on multicast physical downlink shared channel (PDSCH) based on the multicast control information. At step 804, the UE sends HARQ feedback for the one or more scheduled multicast transmissions to the NR network based on the HARQ feedback configuration.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving, by a user equipment (UE), a broadcasting system information block (SIB) configuration for one or more multicast transmissions in a new radio (NR) network, wherein the broadcasting SIB includes bandwidth part (BWP) for the one or more multicast transmissions;
receiving multicast control information for the one or more multicast transmissions through a radio resource control (RRC) message; and
receiving one or more scheduled multicast transmissions on multicast physical downlink shared channel (PDSCH) based on the multicast control information.

2. The method of claim 1, wherein the broadcasting SIB includes at least one element comprising: a Control Resource Set and a search space identifier (ID) indicating a search space of a physical downlink control channel (PDCCH) scrambled by a multimedia broadcast radio network temporary identifier (MB-RNTI).

3. The method of claim 1, wherein the RRC message indicates one or more ongoing NR multicast sessions in a multicast traffic channel (MTCH) information list.

4. The method of claim 1, wherein the UE is in an RRC_CONNECTED state, and wherein the multicast control information is delivered through dedicated signaling with MTCH information that is interested to the UE.

5. The method of claim 1, wherein the multicast control information includes at least one element comprising a control resource set, and a search space ID indicating a search space of PDCCH scrambled by a group RNTI (G-RNTI).

6. The method of claim 1, wherein the multicast control information includes one or more multicast indexes to map different multicast resources to corresponding one or more NR multicast flows of a single multicast session, and wherein the multicast resource is a MTCH or a multicast radio resource (MRB) with corresponding multicast index being a MTCH index and a MRB index.

7. The method of claim 1, wherein the multicast control information includes a MTCH retransmission timer to enable an immediate retransmission of unsuccessful multicast PDSCH transmission.

8. A method, comprising:
receiving, by a user equipment (UE), multicast control information for the one or more multicast transmissions through a radio resource control (RRC) message;
configuring uplink hybrid automatic repeat request (HARQ) feedback for one or more multicast transmission based on the received multicast control information;
receiving one or more scheduled multicast transmissions on multicast physical downlink shared channel (PDSCH) based on the multicast control information; and
sending HARQ feedback for the one or more scheduled multicast transmissions to the NR network based on the HARQ feedback configuration.

9. The method of claim 8, wherein the HARQ configuration is included in a MTCHInfoList.

10. The method of claim 8, wherein the multicast control information includes an uplink HARQ feedback request to indicate whether the HARQ feedback is enabled or disabled.

11. The method of claim 8, wherein the multicast control information includes timing information between a physical downlink shared channel (PDSCH) and a physical uplink control channel (PUCCH) feedback resource.

12. The method of claim 8, wherein the multicast control information includes a HARQ feedback option selecting from a NACK HARQ feedback and an ACK/NACK HARQ feedback.

13. The method of claim 8, wherein the multicast control information includes physical layer feedback resources for a PDSCH carrying a MTCH contents.

14. The method of claim 13, wherein the physical layer feedback resources include a set of PUCCH resources or a set of PUCCH resource instances.

15. A user equipment (UE), comprising:
a transceiver that transmits and receives radio frequency (RF) signal in a new radio (NR) wireless network;
a broadcast module that receives a broadcasting system information block (SIB) configuration for one or more multicast transmissions in the NR network, wherein the broadcasting SIB includes bandwidth part (BWP) for the one or more multicast transmissions;
a control information module that receives multicast control information for the one or more multicast transmissions through a radio resource control (RRC) message; and
a multicast module that receives one or more scheduled multicast transmissions on multicast physical downlink shared channel (PDSCH) based on the multicast control information.

16. The UE of claim 15, wherein the broadcasting SIB includes at least one element comprising: a Control Resource Set and a search space identifier (ID) indicating a search space of a physical downlink control channel (PDCCH) scrambled by a multimedia broadcast radio network temporary identifier (MB-RNTI).

17. The UE of claim 15, wherein the multicast control information includes at least one element comprising a control resource set, and a search space ID indicating a search space of PDCCH scrambled by a group RNTI (G-RNTI).

18. The UE of claim 15, wherein the multicast control information includes one or more multicast indexes to map different multicast resources to corresponding one or more NR multicast flows of a single multicast session, and wherein the multicast resource is a MTCH or a multicast radio resource (MRB) with corresponding multicast index being a MTCH index and a MRB index.

19. The UE of claim 15, wherein the multicast control information includes an uplink HARQ feedback request to indicate whether the HARQ feedback is enabled or disabled.

20. The UE of claim 15, wherein the multicast control information includes physical layer feedback resources for a PDSCH carrying a MTCH contents.
